(19) United States
(12) Patent Application Publication
(10) Pub. No.: US 2018/0108094 A1
(43) Pub. Date: Apr. 19, 2018

(54) OPERATING METHODS AND SYSTEMS FOR UNDERGROUND MINING

(71) Applicant: Caterpillar Inc., Peoria, IL (US)

(72) Inventor: Tina Poole, Sumner (AU)

(73) Assignee: Caterpillar Inc., Peoria, IL (US)

(21) Appl. No.: 15/294,159

(22) Filed: Oct. 14, 2016

(51) Int. Cl. G06Q 50/02; G06Q 10/06

(52) U.S. Cl. CPC G06Q 50/02; G06Q 10/06315

(57) ABSTRACT

Operating an underground mining system includes populating a data model with production plan data and graph data, and calculating a cost associated with assigning a machine from a fleet to a target destination in the underground mine based on a cumulative weights of a subset of a plurality of graph edges. The machine is assigned based upon the calculated cost and dispatched to the target destination according to a navigation plan.

### TECHNICAL FIELD

The present disclosure relates generally to operating machines in an underground mining environment, and more particularly to cost-based calculation of machine assignments.

### BACKGROUND

Underground mines exist throughout the world, and are commonly developed to extract ore at great depths or otherwise under circumstances where surface mining is not practicable. In some instances, an underground mine may be developed beneath an opencast mine that has simply become too deep for continued surface development to be practical. In other instances, geological or topographical factors can make underground development a preferred approach from the start. A typical underground mine, such as a block cave mine, is arranged in regions referred to as panels, designated for extraction. Networks of passageways can pass through and among the panels, enabling equipment and mine personnel to travel throughout the mine, and move material for extraction. A plurality of different points targeted for present extraction, known generally as draw points, are located within each panel. Ore passes are located generally in proximity to panels, and include a chute or other passageway by which extracted ore is sent to a crusher that ultimately provides crushed ore to a conveyance mechanism such as an elevator to lift ore out of the mine for further processing.

Underground mining generally, and by necessity, proceeds according to a relatively sophisticated production plan. Mining geologists, engineers, and other personnel typically generate a production plan that specifies locations and amounts of material that are to be extracted from an underground mine, along with certain factors relating to the manner and ordering of events in extraction of the material. Because underground mining is associated with certain hazards, and commonly requires the prescribed collapsing of material, production plans are typically highly sophisticated and generated with the assistance of computer modeling and simulation.

A so-called draw card is a list of panels that are available and an extraction target required from specific draw points in the panel for a shift at the underground mine. In recent years, there has been increased interest in the application of autonomous or semi-autonomous machine operation in underground mining. In certain state-of-the-art mines, machines known as load-haul-dump (LHD) machines navigate autonomously throughout the mine, under the supervision of one or more operators at a control station. It is typical in such systems for an operator to take over some of the material loading and dumping functions, while navigation and propulsion of the machine throughout the mine is achieved through interaction between on-board computers on the LHD machines and an underground local positioning system.

The viability and success of any mining operation can depend to a great extent on efficiency of the operation of machines and personnel, and development of suitable and effective production plans. Engineers have experimented for decades with computer implemented techniques for assigning certain machines to certain tasks, directing machine traffic, automation, and virtually every other conceivable logistical factor relating to production efficiency, safety and compliance with environmental and legal standards. Commonly owned U.S. Pat. No. 6,741,921 to Cohen et al. is directed to a multi-stage truck assignment system and method. Cohen proposes methodology for providing dispatch assignments to vehicles in an open pit mine environment including a plurality of sources and a plurality of processing sites. Current information about the environment is obtained, and information about optimal criteria for operation and/or production. Based on this information, a production plan is determined, with the production plan and consideration of expected future conditions and other factors used to determine a dispatch assignment for each of the vehicles. As discussed above, there are many different types of mines, and underground mines have a set of specific challenges and requirements that are different from those of open pit mines, such as Cohen et al.

### SUMMARY OF THE INVENTION

In one aspect, a method of operating an underground mining system includes populating a data model, for use in managing operations of a fleet of autonomous or semi-autonomous machines, with production plan data for a panel at an underground mine. The production plan data defines a plurality of target destinations associated with the panel and the plurality of target destinations including a plurality of material draw points and at least one material delivery point. The method further includes populating the data model with graph data for a plurality of different travel routes each ending at one of the plurality of target destinations. The graph data defines a plurality of graph nodes and a plurality of graph edges. The method further includes calculating a cost associated with assigning a machine from the fleet of machines to one of the plurality of target destinations based at least in part on a weight of a subset of the plurality of graph edges, the subset of the plurality of graph edges being defined by one of the plurality of different travel routes. The method still further includes assigning the machine to the one of the plurality of target destinations based at least in part on the calculated cost, and dispatching the assigned machine to the one of the target destinations according to a navigation plan that is based upon the one of the plurality of different travel routes.

In another aspect, an underground mining system includes a fleet of loader machines each including on-board electronic controls for autonomous navigation within an underground mine, and a computer system structured to communicate with each of the loader machines in the fleet. The computer system includes a machine readable storage medium storing a data model for use in managing operations of the fleet of loader machines. The data model is populated with production plan data for a panel at the underground mine, the production plan data defining a plurality of target destinations associated with the panel and the plurality of target destinations including a plurality of material draw points and at least one material delivery point. The data model is further populated with graph data for a plurality of different travel routes each ending at one of the plurality of target destinations. The graph data defines a plurality of graph nodes and a plurality of graph edges. The computer system is further structured to calculate a cost associated with assigning one of the loader machines to one of the plurality of target destinations based at least in part on a weight of a subset of the plurality of graph edges. The subset of the plurality of graph edges is defined by one of the plurality of different travel routes. The computer system is further structured to assign the one of the loader machines to the one of the plurality of target destinations based at least in part on the calculated cost, and to dispatch the assigned machine to the one of the target destinations according to a navigation plan that is based upon the one of the plurality of different travel routes.

### BRIEF DESCRIPTION OF THE DRAWINGS

FIG. 1 is a diagrammatic view of an underground mining system, according to one embodiment;

FIG. 2 is a conceptual logic diagram of graph data, according to one embodiment;

FIG. 3 is a class diagram of route edge elements and cardinality, according to one embodiment;

FIG. 4 is a block diagram illustrating edge weight attributes in a graph, according to one embodiment;

FIG. 5 is a flowchart of a process, according to one embodiment; and

FIG. 6 is a flowchart of another process, according to one embodiment.

### DETAILED DESCRIPTION

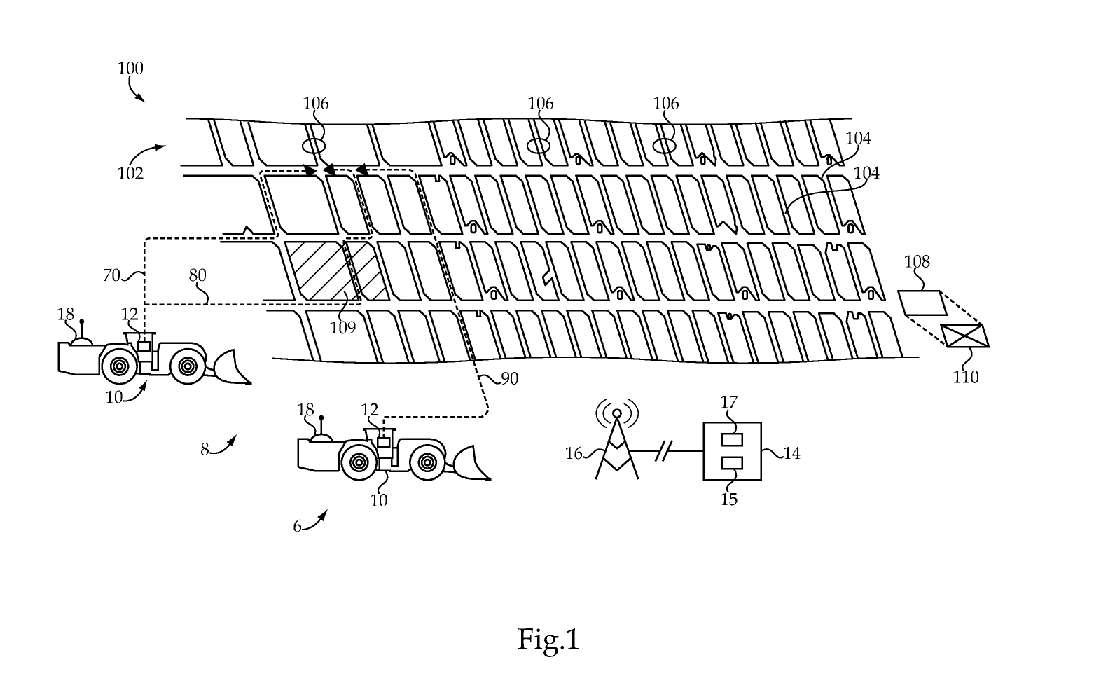

Referring to FIG. 1, there is shown an underground mining system 6 at an underground mine 100. Underground mining system 6 may include a fleet 8 of loading machines 10 in the nature of load-haul-dump (LHD) machines, which are configured for autonomous or semi-autonomous operation within underground mine 100, and include on-board electronic controls 12 for autonomous navigation within underground mine 100. Those skilled in the art will be familiar with various features of LHD machines 10 relating to power, propulsion, steering, and equipment for loading and dumping material such as ore or overburden. Embodiments are contemplated herein where machines 10 autonomously navigate through passages 104 within underground mine 100, by way of receipt of local positioning system signals from a local positioning system resident in underground mine 100, but are manually and remotely controlled for the loading and dumping of material. In other instances, operation could be entirely autonomous, or could integrate manual control to a relatively greater degree. Each of machines 10 could further be equipped with a receiver 18 for receiving local positioning system data, and also assignment and dispatching data. As will be further apparent from the following description, underground mining system 6 is uniquely configured for efficient task assignment, dispatching and overall operation.

Underground mining system 6 may further include a computer system 14 including one or more data processors 15 in communication with a machine readable storage medium 17, and with a transmitter 16. Transmitter 16, or a plurality of transmitters, may be positioned at one or more locations in underground mine 100 and structured to transmit control signals, assignment data, and any of a variety of other sorts of information to machines 10 and other computerized machines or personnel within underground mine 100 for purposes further discussed herein. Underground mine 100 can include one or more panels 102 for extraction of material at a plurality of draw points 106. Draw points 106 can be understood as locations within panel 102 that are designated for extraction of material to be loaded by one of machines 10 and transported to a delivery location 108, such as a chute leading to an ore crusher 110. For purposes of the present description, draw points 106 and delivery location 108 can be understood as target destinations. As further discussed herein, computer system 14 may be structured to assign any one of machines 10 to any one of draw points 106 that are designated for extraction of material according to a production plan. As noted above, a draw card may designate extraction locations, in other words draw points, and extraction targets, for a given shift at a mine. The draw cards and production plan data may be updated as material removal progresses. As will be further understood from the following description, computer system 14 will not only efficiently assign, route and dispatch machines 10, but also do so in compliance with the applicable draw card.

To this end, machine readable storage medium 17 may store a data model for use in managing operations of fleet 8, and potentially other machines and activities at underground mine 100. The stored data model may be populated with production plan data for a panel such as panel 102 at underground mine 100. The production plan data may define a plurality of target destinations associated with panel 102, and the plurality of target destinations may include a plurality of material draw points and at least material delivery point. Thus, the production plan data, in addition to other types of data, may include location coordinates for each of draw points 106 and the one or more material delivery points 108. Those skilled in the art will appreciate that the production plan data may indicate the locations for extraction of material, the locations at which the material can be delivered, and potentially other data such as amounts of material and an order of operations for the extraction, or even potentially other data such as timing or manner of performing various tasks related to extracting and delivering material.

Also shown in FIG. 1 are two routes 70 and 80 that extend from a current location of a first one of machines 10 to one of draw points 106. Yet another route 90 extends from a present location of a second one of machines 10 to the same draw point 106. It will be appreciated that the manner by which any machine within underground mine 100 can travel to any location within underground mine 100 can vary based upon the available travel paths or travel routes and also potentially properties or characteristics of those travel routes. In an underground mine it is common for passages to be laid out generally in a grid or other ordered pattern, such that in many instances a series of right angle turns and straight passageways can be followed to get from one point to another. In other mines, the local geography and mine design may be relatively more complex. In any case, underground mines commonly include speed zones, exclusion zones, registration zones, that can bear on the suitability or availability of a particular travel route through the underground mine. In addition, other mine vehicles, autonomous or conventional, sprayer systems and still other mobile and fixed obstacles or potential obstacles can reside within the mine or move about the mine and affect the suitability or availability of a particular route. In FIG. 1, a registration zone 109 is shown that could require only certain vehicles be admitted or allow admission only under certain conditions. As further discussed herein, computer system 14 may be equipped to assign machines 10 to particular draw points, or particular delivery points, based upon fixed and dynamic factors such as those listed above, and others, that can affect the suitability or availability of certain routes.

The data model stored on machine readable storage medium 17 may further be populated with graph data for a plurality of different travel routes, and each of the travel routes ending at one of the plurality of target destinations. In the illustrated case, travel routes 70, 80 and 90 extend from current locations of machines 10 to the same draw point 106. The graph data populating the data model may include additional data for all of passageways 104, such that a travel route between one point and another point could have many possible forms. Computer system 14 could be considering and acting upon, as further described herein, graph data for all or virtually all of the possible travel routes between two points within underground mine 100, and as further discussed herein will ultimately select a travel route and an assignment of a machine to a particular draw point that is considered optimum for a particular machine at a particular point in time. Considered from a different perspective, computer system 14 could determine the best or optimum machine to service a particular draw point or travel to a particular ore pass from among a plurality of potentially available machines in fleet 8.

It should also be appreciated that system 6 could include dozens of loader machines such as machine 10, dozens or potentially even hundreds of draw points in one or more panels of interest, and numerous ore passes. According to the present disclosure, computer system 14 may be structured to orchestrate the assignment of the numerous machines to the numerous draw points and ore passes in a manner that takes account of factors such as travel distance, travel time, wait or delay times, requirements for registration, exclusion, water sprayer on or off state, speed limits, and potentially still other factors. While it is contemplated that in a practical implementation strategy machines 10 will be more or less interchangeable, and may be substantially identical, to one another, the present disclosure is not limited in this regard. Certain machines could be better suited, such as by having different sizes, to different draw points or different travel routes. Accordingly, assignment of machines based also upon suitability of a given machine for a particular purpose could be considered.

In a practical implementation strategy, computer system 14 is further structured to calculate a cost associated with assigning one of machines 10 to one of the plurality of target destinations based at least in part on a cumulated weight of a subset of the plurality of graph edges defined by the graph data populating the data model. In one instance, the graph data may be understood to define both a plurality of graph nodes and a plurality of graph edges, with the graph nodes associated with physical locations within underground mine 100 where direction or conditions of travel change. For instance, a graph node could be associated with an intersection between passageways, with each of the passageways representing a leg of a travel route. A graph node could also be associated with a transition between one speed zone and another speed zone, or a passage with a water sprayer transitioning to a passage with no water sprayer. The subset of the plurality of graph edges of interest at any time may be defined by one of the plurality of different possible travel routes to a particular target destination.

For example, computer system 14 might be understood to evaluate the cost of the first one of machines 10 traveling by way of route 70 to the designated draw point 106, versus a cost of the same machine traveling by way of route 80 to the designated draw point 106. It can be noted that the route 80 passes through registration zone 109. Each of routes 70 and 80 may be associated with a different subset of the plurality of graph edges defined by the graph data populating the data model. Computer system 14 may also be structured to calculate a cost associated with assigning the second one of machines 10 to the same designated draw point 106, to travel there by way of route 90. Computer system 14 is still further structured to assign the one of machines 10, in the illustrated case the left machine 10 in FIG. 1, to the one of the plurality of target destinations based at least in part on the calculated cost, and further structured to dispatch the now assigned machine 10 to the one of the target destinations according to a navigation plan that is based upon the one of the plurality of different travel routes.

From the foregoing description it will be appreciated that computer system 14 may be considering the cost associated with sending a first one of machines 10 to a designated draw point, or to a designated ore pass, according to a certain travel route, versus sending that same machine to the same target destination by way of a different travel route. By the same token, computer system 14 might be considering the cost of sending a first machine to a designated draw point or ore pass according to one route versus sending a different machine to that same designated draw point according to a different travel route. As noted above, the total number of machines in play and the total number of draw points and/or ore passes and/or other target destinations could be much larger than that which is illustrated, resulting in the orchestration of machine operations on a grand scale, and the illustration and discussion herein is but a simplified example.

In any event, embodiments are contemplated where only the relatively simple case of calculating a cost associated with one travel route and calculating a cost associated with a second travel route, and comparing those costs, is implemented. In a practical implementation strategy, the calculated costs may each include a time cost. It will also be appreciated in view of the preceding discussion that various fixed factors can bear upon the time that it takes any of the machines in fleet 8 to travel a particular travel route, as well as dynamic factors that can change more or less instantaneously, or gradually over time. In a further practical implementation strategy, the calculating of the cost may include calculating each cost based at least in part upon a cumulative weight of the graph edges in a particular subset of graph edges of interest, as noted above. The calculating may further include calculating the cost by way of Dijkstra's single source shortest path (SSSP) algorithm. It will be appreciated that the implementation of Dijkstra's SSSP algorithm can allow the shortest distance to a target destination to be selected such that the cost of assigning a particular machine to a particular destination will depend upon the distance that particular machine is from that target destination. As explained herein, however, the various other factors that can affect the actual time, such as speed zones, to traverse a given segment of a travel route, can cause paths other than the shortest path to be selected. Analogously, such factors can cause a machine other than the machine that is in closest proximity to a target destination to be selected for travel to that target destination. Moreover, while a principal application of the present disclosure may include calculating a cost for extraction of one of a plurality of material draw points and/or a cost for delivery at one or more material delivery points, the present disclosure is not thereby limited, and assignment of machines to certain tasks and dispatching to certain locations for purposes other than material extraction or material delivery could be implemented without departing from the scope of the present disclosure.

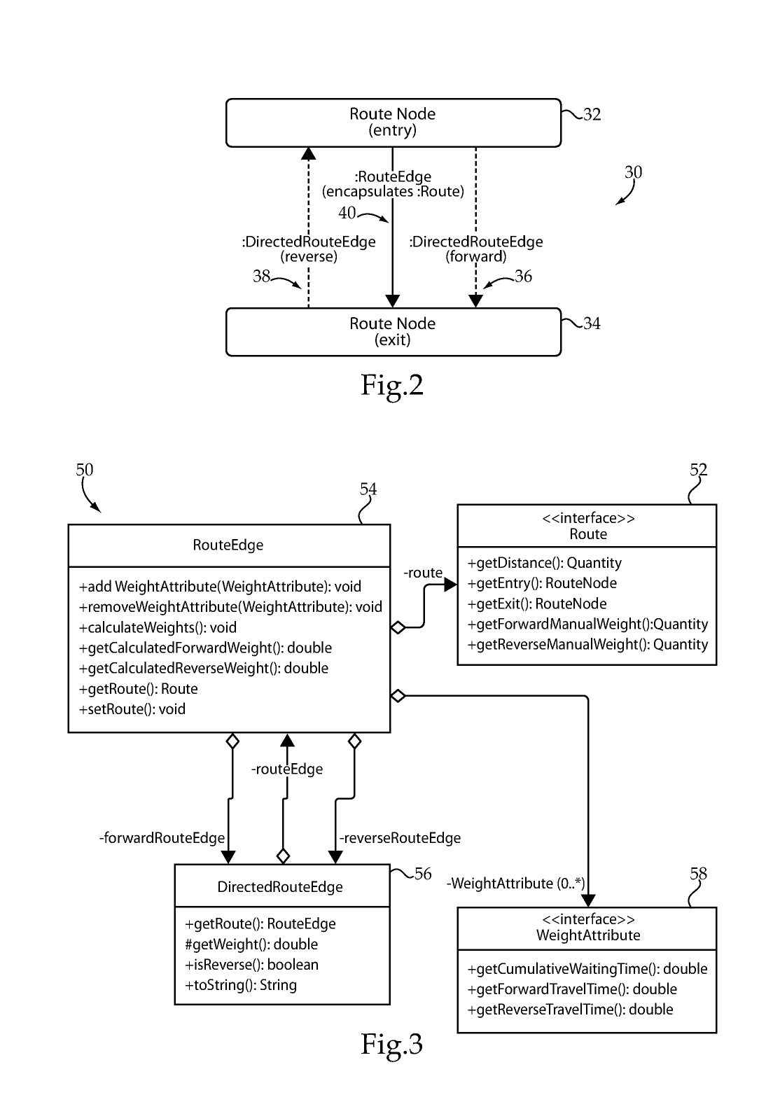

As discussed above, among other things it is the exploitation of graph edge weighting that is considered to enable certain advantages afforded by the present disclosure. Referring also now to FIG. 2, there is shown a diagram 30 depicting aspects of the data model at a logical level. Diagram 30 depicts a first route node 32, that can represent entry, and a second route node 34, that can represent exit, to and from a segment of a travel route. Relating route nodes 32 and 34 is a route edge 40, that encapsulates a reverse directed route edge 38 and a forward directed route edge 36. Certain processing aspects of the present disclosure can require route edges be unidirectional, therefore directionality in the graph edges could be represented in the form of different edge weight attributes. Referring also now to FIG. 3, there is shown another diagram 50 illustrating classes and objects depicting details and cardinality of the graph data in the data model. In diagram 50, a first block 52 is shown for a route class, whereas a second block 54 is shown for a route edge, a third block 56 is shown for a directed route edge, and a fourth block 58 shown for a weight attribute class.

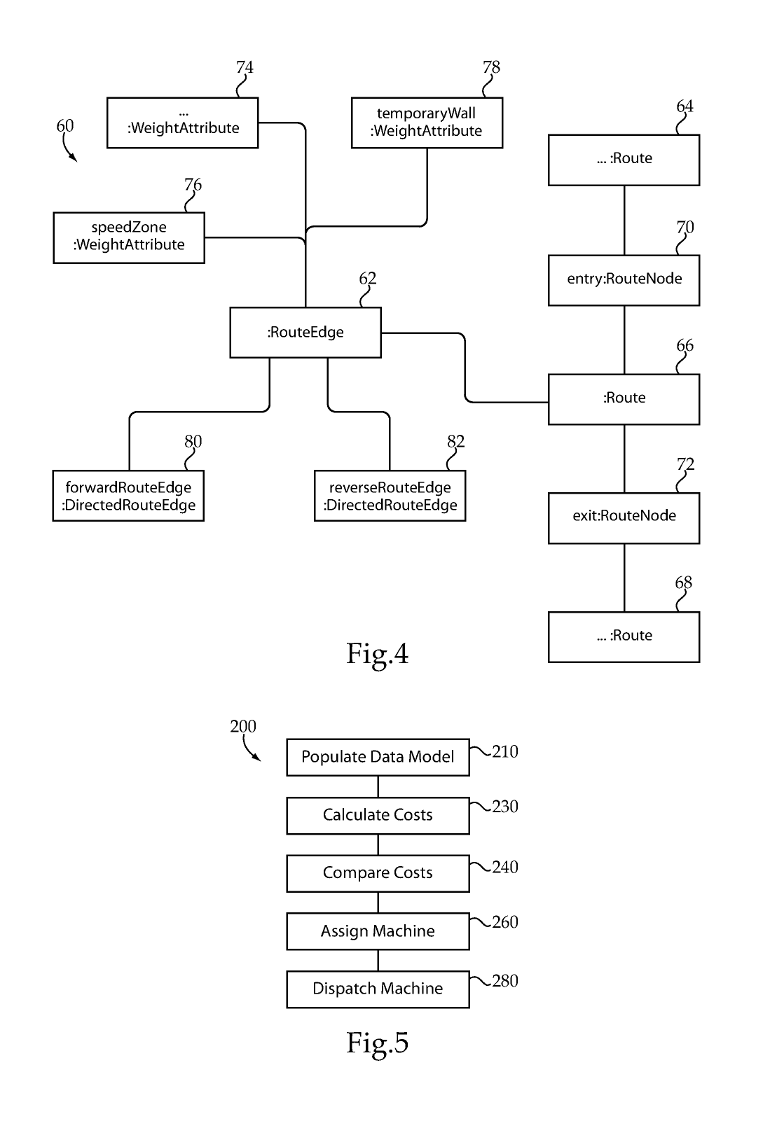

Referring also now to FIG. 4, there is shown a diagram 60 for an example of a route edge that has interference from a temporary wall and a speed zone. A temporary wall might be a barrier erected within underground mine 100 on a temporary basis, reflecting a graph edge dynamic attribute as discussed above. The temporary wall could also be understood as a travel interference edge weight attribute generally, as other travel interference attributes such as a water spray system or another vehicle, a material collapse, or still another dynamic attributes can be considered. When there is no travel interference the edge weight of that attribute might be zero. When there is travel interference the weight might be +1 or −1, for example. Blocks 64, 66, and 68 designate different routes, whereas blocks 70 and 72 represent entry and exit of a route node. Route edge is shown at block 62, and is associated with temporary wall weight attribute 78, a speed zone weight attribute 76, and another weight attribute 74. As suggested above, directionality can be addressed by way of weight attributes, and thus forward route edge attribute is shown at block 80 and reverse route edge attribute is shown at block 82.

### INDUSTRIAL APPLICABILITY

Referring now also to FIG. 5, there is shown a flowchart 200 illustrating high level steps in setup and data processing methodology in operating an underground mining system according to the present disclosure. The process of flowchart 200 includes populating the data model at block 210. As discussed above, the data model can be populated with production plan data, and populated with graph data. Taking account of the current state of the mine or events at the mine can require periodically repopulating the data model with updated graph data, and at least periodically updated production plan data. From block 210, the logic may advance to block 230 to calculate costs, as discussed herein. From block 230 the logic may advance to block 240 to compare the calculated costs, such as a time cost of assigning a first machine to a first draw point versus assigning a second machine to the first draw point, or a time cost of assigning a first machine to a first draw point versus assigning to a second draw point, or comparison of still other cost scenarios. From block 240, the logic may advance to block 260 to assign a machine to a target destination. Assignment of the machine in this manner could include transmitting the pertinent information relating to assignment, such as target destination location coordinates and navigation path coordinates, to one of the autonomous machines. From block 260, the logic may advance to block 280 to dispatch the machine, which could include transmitting a control signal instructing the machine to commence navigating to the target destination. The navigation path coordinates would typically include the coordinates corresponding to the travel route considered in the cost calculation.

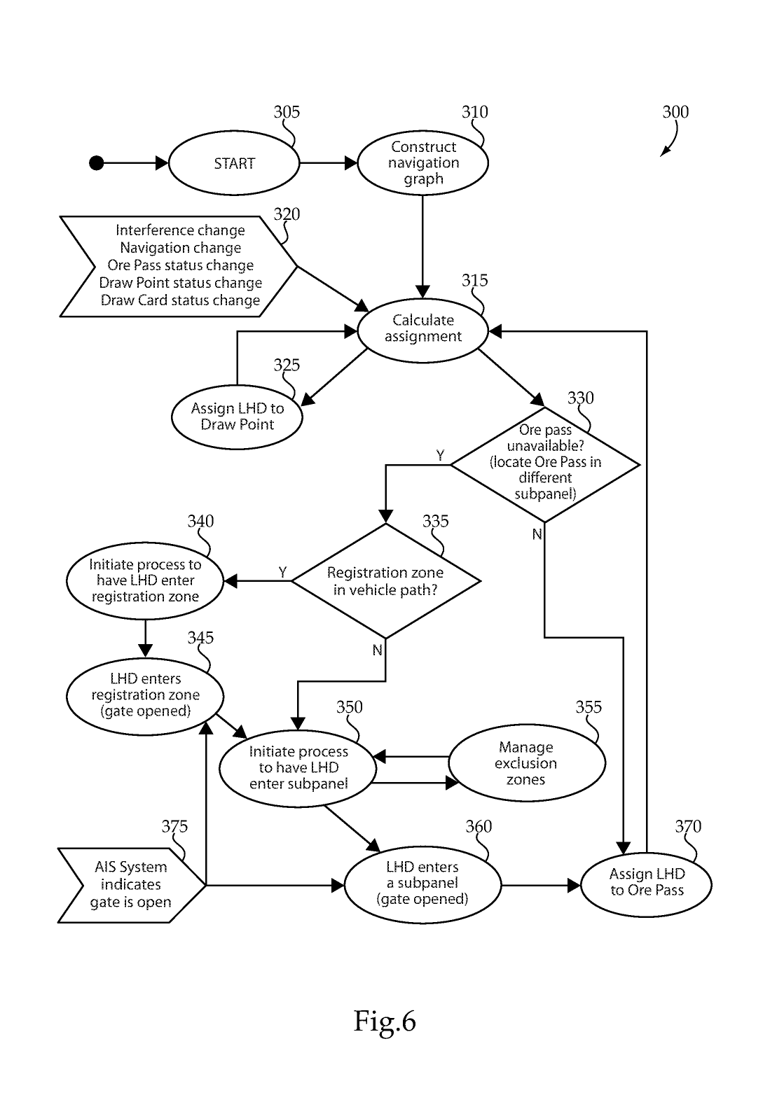

Referring to FIG. 6, there is shown another flowchart 300 illustrating additional details of operation and control of an underground mining system according to the present disclosure. At block 305, the logic may start or initialize, and advance to block 310 to construct the navigation graph. Operations at block 310 could include all of the operations set forth in FIG. 5. From block 310, the logic may advance to block 315 to calculate the assignment. At block 320, a plurality of inputs, relating to interference changes, navigability changes, or path status changes, draw point status changes, or draw card status changes can be input for consideration in calculation of the assignment, including calculation of the cost. From block 315, if a machine is to be assigned to a draw point, the logic may advance to block 325 to assign the machine (or “LHD” as indicated in FIG. 6) to a draw point. If the LHD is hauling, the logic may advance to block 330 to query whether the ore pass is unavailable. If so, an ore pass may be located in a different subpanel, for instance. If the ore pass is unavailable, the logic may advance to block 335. If the ore pass is not unavailable, the logic may advance to block 370 to assign the LHD to an ore pass. If a registration zone is in the vehicle path at block 335, the logic may advance to block 340 to initiate the process to have the LHD enter the registration zone. If no, the logic may advance from block 335 to block 350 to initiate the process to have the LHD enter a subpanel. At block 355, exclusion zones may be managed, such as where the subpanel is occupied by another LHD. Managing of the exclusion zones could include reassigning the LHD to a different subpanel, executing a wait cycle, or taking some other action. From block 340, the logic can advance to block 345 so that the LHD enters the registration zone, such as by opening a gate. An area isolation system may indicate the gate is open, such as at block 375. From block 345, the logic may also advance to block 350 to initiate the process to have the LHD enter the subpanel, as noted above. From block 350, the logic may advance to block 360, such that the LHD enters the subpanel. It will be recalled that in a practical implementation strategy an operator might take over to remotely but manually operate the LHD to obtain a load or dump a load of material. Accordingly, in parallel with or following block 360, an operator might remotely operate the LHD to obtain a load of material. From block 360, the logic may advance to block 370 to assign the LHD to an ore pass. From block 370, the logic may return to block 315 to calculate another assignment.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of operating an underground mining system comprising:
populating a data model, for use in managing operations of a fleet of autonomous or semi-autonomous machines, with production plan data for a panel at an underground mine, the production plan data defining a plurality of target destinations associated with the panel and the plurality of target destinations including a plurality of material draw points and at least one material delivery point;
populating the data model with graph data for a plurality of different travel routes each ending at one of the plurality of target destinations, the graph data defining a plurality of graph nodes and a plurality of graph edges;
calculating a cost associated with assigning a machine from the fleet of machines to one of the plurality of target destinations based at least in part on a weight of a subset of the plurality of graph edges, the subset of the plurality of graph edges being defined by one of the plurality of different travel routes;
assigning the machine to the one of the plurality of target destinations based at least in part on the calculated cost; and
dispatching the assigned machine to the one of the target destinations according to a navigation plan that is based upon the one of the plurality of different routes.

2. The method of claim 1 wherein the calculating of the cost includes calculating the cost based at least in part upon a cumulative weight of the graph edges in the subset.

3. The method of claim 2 wherein the calculating of the cost further includes calculating a time cost.

4. The method of claim 3 wherein the calculating of the cost further includes calculating the cost by way of Dijkstra's single source shortest path (SSSP) algorithm.

5. The method of claim 3 further comprising calculating a second cost associated with at least one of, assigning the machine to a second one of the plurality of target destinations or assigning a second machine to the first one of the plurality of target destinations, and comparing the first calculated cost with the second calculated cost.

6. The method of claim 5 wherein the second calculated cost is based in part on cumulative weights of a second subset of graph edges defined by a second one of the plurality of different travel routes and in part on an expected delay time in availability of the at least one material delivery point location.

7. The method of claim 6 wherein the delay time is a delay time in availability of an ore pass.

8. The method of claim 1 wherein the populating of the data model with graph data further includes populating the data model with graph data defining a graph edge having at least one dynamic weight attribute.

9. The method of claim 7 wherein the at least one dynamic weight attribute includes a travel interference weight attribute.

10. The method of claim 1 wherein the populating of the data model with graph data further includes populating the data model with graph data defining a graph edge having a forward direction attribute and a reverse direction attribute.

11. The method of claim 1 wherein the calculating of the cost further includes calculating a cost for extraction at one of the plurality of material draw points or a cost for delivery at the at least one material delivery point location.

12. An underground mining system comprising:
a fleet of loader machines each including on-board electronic controls for autonomous navigation within an underground mine;
a computer system structured to communicate with each of the loader machines in the fleet, and including a machine readable storage medium storing a data model for use in managing operations of the fleet of loader machines;
the data model being populated with production plan data for a panel at the underground mine, the production plan data defining a plurality of target destinations associated with the panel and the plurality of target destinations including a plurality of material draw points and at least one material delivery point;
the data model further being populated with graph data for a plurality of different travel routes each ending at one of the plurality of target destinations, the graph data defining a plurality of graph nodes and a plurality of graph edges;
the computer system being further structured to calculate a cost associated with assigning one of the loader machines to one of the plurality of target destinations based at least in part on a weight of a subset of the plurality of graph edges, the subset of the plurality of graph edges being defined by one of the plurality of different travel routes; and
the computer system being further structured to assign the one of the loader machines to the one of the plurality of target destinations based at least in part on the calculated cost, and to dispatch the assigned machine to the one of the target destinations according to a navigation plan that is based upon the one of the plurality of different travel routes.

13. The system of claim 12 wherein the computer system is further structured to calculate a second cost associated with at least one of, assigning the first one of the loader machines to a second one of the plurality of target destinations or assigning a second one of the loader machines to the first one of the plurality of target destinations, and comparing the first calculated cost with the second calculated cost.

14. The system of claim 13 wherein the first calculated cost and the second calculated cost each include a time cost.

15. The system of claim 14 wherein the computer system is further structured to calculate the first cost and the second cost based at least in part, respectively, on cumulative weights of a first subset of the graph edges defined by the first one of the plurality of different travel routes and cumulative weights of a second subset of the graph edges defined by a second one of the plurality of different travel routes.

16. The system of claim 12 wherein the data model is populated with graph data defining a graph edge having at least one dynamic weight attribute.

17. The system of claim 12 wherein the at least one dynamic weight attribute includes a travel interference weight attribute.

18. The system of claim 17 wherein the travel interference weight attribute includes the presence of an exclusion zone in the underground mine or the state of an exclusion zone.
